(19) United States
(12) Patent Application Publication
(10) Pub. No.: US 2007/0010303 A1
(43) Pub. Date: Jan. 11, 2007

(54) High quality optical windows for mobile phones and cameras

(75) Inventor: Mikko Jalonen, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/175,520

(22) Filed: Jul. 5, 2005

(51) Int. Cl. B29D 11/00; H04M 1/00

(52) U.S. Cl. 455/575.8; 264/2.2

(57) ABSTRACT

This invention describes a method for fabricating an electronic device with high quality optical protective windows using an injection compression molding (ICM) method for making these windows. The optical window manufactured by the ICM method is attached to the electronic device, wherein said optical window is for protecting a display, a sensor, a sensor screen, an important optical surface or other similar components of the electronic device.

### TECHNICAL FIELD

This invention generally relates to electronic devices and more specifically to making electronic devices with high quality optical protective windows.

### BACKGROUND ART

Technology called injection compression molding (ICM) (also called injection coining and stamping) is a variation of traditional injection molding for mass-producing low stress optical parts. The ICM is an extension of the traditional injection molding by incorporating a mold compression action (e.g., using a moving member of a mold cavity for this additional compression during or after the injection) to compact the polymer material for producing parts with dimensional stability and surface accuracy. The character of the ICM process is the way it compensates for a part shrinkage (thermal contraction).

The ICM process significantly improves the optical quality of the optical part (e.g., lenses). One of the problems in traditionally molded plastic optical parts is an optical birefringence, which is caused by the molding in stresses. The optical birefringence is defined by a difference in an index of refraction for two optical waves polarized in perpendicular directions and propagating through the optical part. The optical birefringence can significantly reduce an optical performance (e.g., causing a double-vision) of an electronic device such as a liquid crystal display, a camera, etc.

### DISCLOSURE OF THE INVENTION

The object of the present invention is to provide a method for fabricating electronic devices with high quality optical protective windows using an injection compression molding (ICM) method for making these windows. The optical quality of the optical protecting windows is significantly improved (e.g., reducing an optical birefringence, distortion, etc.) compared to the windows traditionally manufactured using injection molding.

According to a first aspect of the invention, a method for fabricating an electronic device with an optical window, comprises the steps of: making the optical window using injection compression molding; and attaching the optical window to the electronic device, wherein the optical window is for protecting a display, a sensor, a sensor screen, or an optical surface of the electronic device.

According further to the first aspect of the invention, the electronic device may be a portable device, a wireless communication device, a mobile phone, a digital personal assistant or a camera.

Further according to the first aspect of the invention, the optical window may have flat surfaces.

Still further according to the first aspect of the invention, the optical window may have at least one curved surface.

According further to the first aspect of the invention, a quality of the optical window may be determined by an optical birefringence, wherein the optical birefringence is defined by a difference in an index of refraction for two optical waves polarized in perpendicular directions and propagating through the optical window.

According still further to the first aspect of the invention, the optical window may be made of polymethyl methacrylate (PMMA).

According yet further still to the first aspect of the invention, the step of making the optical window using injection compression molding, may comprise: expanding a volume of a cavity that its expanded thickness is larger than a desired thickness of the optical window by a predetermined value; injecting a molten thermoplastic resin into the cavity through an injection cylinder; compressing the cavity using moving at least one member of the cavity to a predetermined thickness which is within a prescribed tolerance of the desired thickness of the optical window, wherein the compressing is performed during or after the injecting and a speed, a moving distance and timing of the moving is pre-programmed by a system operator; and taking out the obtained optical window from the cavity after the desired thickness of the optical window is formed.

According to a second aspect of the invention, an electronic device, comprises: a display, a sensor, a sensor screen, or an optical surface; an optical window attached to the electronic device for protecting the display, the sensor, the sensor screen, or the optical surface, wherein the optical window is made using injection compression molding.

According further to the second aspect of the invention, the electronic device may be a portable device, a wireless communication device, a mobile phone, a digital personal assistant or a camera.

Further according to the second aspect of the invention, the optical window may have flat surfaces.

Still further according to the second aspect of the invention, the optical window may have at least one curved surface.

According still further to the second aspect of the invention, the quality of the optical window may be determined by an optical birefringence, wherein the optical birefringence is defined by a difference in an index of refraction for two optical waves polarized in perpendicular directions and propagating through the optical window.

According yet further still to the second aspect of the invention, the optical window may be made of polymethyl methacrylate (PMMA).

Yet still further according to the second aspect of the invention, the making of the optical window using injection compression molding, may comprise: expanding a volume of a cavity that its expanded thickness is larger than a desired thickness of the optical window by a predetermined value; injecting a molten thermoplastic resin into the cavity through an injection cylinder; compressing the cavity using moving at least one member of the cavity to a predetermined thickness which is within a prescribed tolerance of the desired thickness of the optical window, wherein the compressing is performed during or after the injecting and a speed, a moving distance and timing of the moving is pre-programmed by a system operator; and taking out the obtained optical window from the cavity after the desired thickness of the optical window is formed.

### BRIEF DESCRIPTION OF THE DRAWINGS

For a better understanding of the nature and objects of the present invention, reference is made to the following detailed description taken in conjunction with the following drawings, in which:

FIG. 1 is a schematic diagram showing a cavity which is expanded more than the volume of an optically molded window before injection;

FIG. 2 is a schematic diagram showing that a molten thermoplastic resin is injected into the expanded cavity;

FIG. 3 is a schematic diagram showing that the expanded cavity is compressed to a predetermined thickness; and

FIG. 4 is a view of a mobile phone showing an optical window manufactured by an injection compression molding method described in FIGS. 1 through 3 and attached to the mobile phone for protecting display screen area, according to an embodiment of the present invention.

### BEST MODE FOR CARRYING OUT THE INVENTION

The present invention provides a method of fabricating an electronic device with high quality optical protective windows (or optical windows) using an injection compression molding (ICM) method for making these windows. The optical window manufactured by the ICM method is attached to the electronic device, wherein said optical window is for protecting a display, a sensor, a sensor screen, an important optical surface or other similar components of the electronic device.

According to an embodiment of the present invention, the electronic device can be a portable device, a wireless communication device, a mobile phone, a digital personal assistant, a camera or a similar device. Furthermore, the optical protection optical windows can have various surface profiles, e.g., flat surfaces, curved surfaces, etc. Furthermore, according to an embodiment of the present invention, various plastic polymer materials can be utilized for manufacturing the optical protective windows using the ICM method, e.g., the optical windows can be made of polymethyl methacrylate (PMMA).

According to an embodiment of the present invention, the optical quality of the optical protective windows can be significantly improved (e.g., by reducing an optical birefringence, distortion, etc.) compared to the windows traditionally manufactured using the injection molding. An important quality aspect of the optical window can be determined by an optical birefringence, wherein said optical birefringence is defined by a difference in an index of refraction for two optical waves polarized in perpendicular directions and propagating through the optical window. Using the ICM method helps to reduce/remove the phenomenon of the optical birefringence.

The ICM is an extension of the traditional injection molding by incorporating a mold compression action. In this process the mold cavity (or “cavity”) has an enlarged thickness initially which allows a polymer melt (or a molten thermoplastic resin) to proceed readily to the extremities of the cavity under relatively low pressure. At some time during or after filling, the mold cavity thickness is reduced by a mold closing movement (by moving at least one member of the cavity, e.g., a moving core), which forces the melt to fill and pack out the entire cavity. The mold compression action results in a more uniform pressure distribution across the cavity, leading to more homogenous physical properties and less shrinkage, warpage, and molded-in stresses than are possible with the conventional injection molding, thus improving the optical birefringence performance.

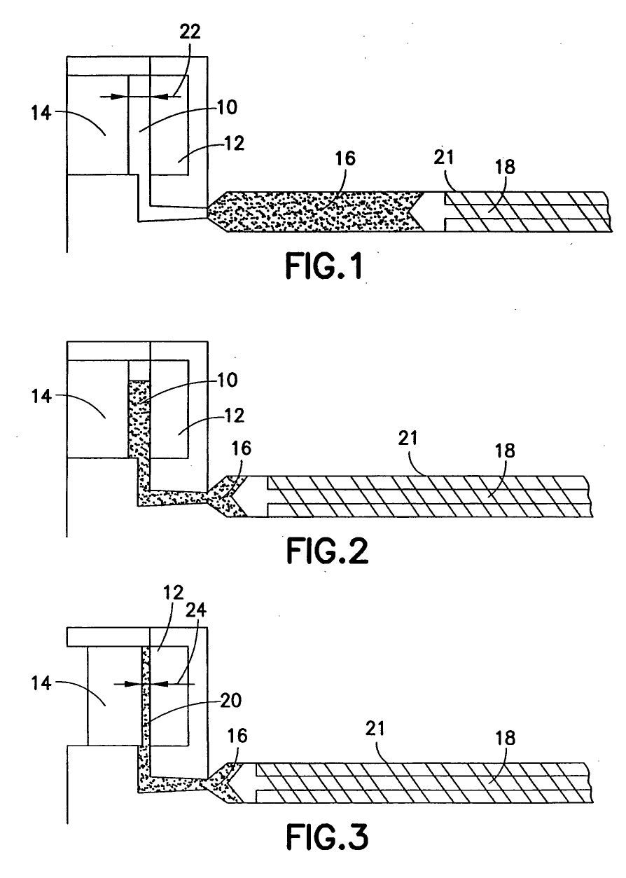

FIGS. 1-3 provide one possible example among others of the ICM process. FIG. 1 is a schematic diagram of a first stage wherein a cavity 10 is expanded before injection more than the volume required for a molded optical window, i.e., an expanded thickness 22 of the cavity 10 is larger than a desired thickness of the optical window by a predetermined value (which is determined by the ICM process); the expanded thickness 22 of the cavity 10 is controlled by a fixed core 12 and by a movable core 14 as shown. FIG. 2 shows a schematic diagram of a second stage wherein a molten thermoplastic resin 16 is injected into the expanded cavity 10 by moving a screw 18 such that the molten thermoplastic resin 16 partially occupies the cavity 10 as shown in FIG. 2. FIG. 3 shows a schematic diagram of a third stage when the expanded cavity is compressed to a predetermined thickness 24 of a compressed cavity 20 using the movable core 14. To achieve the best possible quality of the optical window manufactured by the process shown in FIGS. 1-3, the backflow of the molten thermoplastic resin 16 to a cylinder 21 during the compression stage (see FIG. 3) is prevented, e.g., by using a hotrunner with a valve gate solution or a coldrunner with a higher holding pressure.

The predetermined thickness 24 is within a prescribed tolerance of the desired thickness of said optical window, wherein said compressing stage (the third stage) shown in FIG. 3 can be performed during or after the injecting stage (the second stage) shown in FIG. 2. A speed, a moving distance and timing of moving of the movable core 14 is pre-programmed by a system operator. After a cool-down period, the obtained optical window with the desired thickness is removed from the compressed cavity 20.

The basic process shown in FIGS. 1-3 has many variations. Details of this process and its variations can be found in many publications which are incorporated here by reference. These publications include (but are not limited to):

“Injection Molding Handbook”, Edited by T. A. Osswald. L-S Turng and P. J. Gramann, Carl Hanser Verlag, 2002, pp. 384-461;

U.S. Pat. No. 6,705,725, “Injection Compression Molding Method for Optically Molded Products”, by K. Gotoh and H. Ichioka, Mar. 16, 2004;

U.S. Pat. No. 6,616,868, “Injection Compression Molding Method for Optically Formed Products”, by K. Gotoh and H. Ichioka, Sep. 9, 2003;

U.S. Pat. No. 6,767,482, “Injection Compression Molding Method and Injection Compression Molding Machine”, by H. Yoshimura and S. Kishi, Jul. 27, 2004;

U.S. Pat. No. 6,576,317, “Optical disk and Injection Compression Molding Die for Producing the Same”, by K. Gotoh and H. Ichioka, Jun. 10, 2003; and

I. H. Kim, S. J. Park, S. T. Chung and T. H. Kweon, “Numerical Modeling of Injection/Compression Molding for Center-Gated Disk: t I. Injection Molding with Viscoelastic Compressible Fluid Model”, Polymer Engineering and Science, vol. 39, No. 10, pp 1030-1942, 1999.

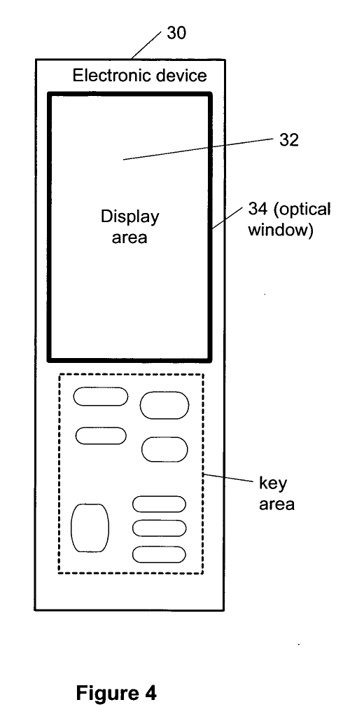

After manufacturing the optical protective window using the ICM method, the optical window 34 is attached to an electronic device 30 as shown in FIG. 4. According to an embodiment of the present invention, the optical window 34 covers and protects a display area 32 of the electronic device 30.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method for fabricating an electronic device with an optical window, comprising the steps of:
making said optical window using injection compression molding; and
attaching said optical window to said electronic device, wherein said optical window is for protecting a display, a sensor, a sensor screen, or an optical surface of said electronic device.

2. The method of claim 1, wherein said electronic device is, a portable device, a wireless communication device, a mobile phone, a digital personal assistant or a camera.

3. The method of claim 1, wherein said optical window has flat surfaces.

4. The method of claim 1, wherein said optical window has at least one curved surface.

5. The method of claim 1, wherein a quality of said optical window is determined by an optical birefringence, wherein said optical birefringence is defined by a difference in an index of refraction for two optical waves polarized in perpendicular directions and propagating through said optical window.

6. The method of claim 1, wherein said optical window is made of polymethyl methacrylate (PMMA).

7. The method of claim 1, wherein said step of making said optical window using injection compression molding, comprises:
expanding a volume of a cavity that its expanded thickness is larger than a desired thickness of said optical window by a predetermined value;
injecting a molten thermoplastic resin into said cavity through an injection cylinder;
compressing said cavity using moving at least one member of said cavity to a predetermined thickness which is within a prescribed tolerance of said desired thickness of said optical window, wherein said compressing is performed during or after said injecting and a speed, a moving distance and timing of said moving is pre-programmed by a system operator; and
taking out the obtained optical window from the cavity after the desired thickness of said optical window is formed.

8. An electronic device, comprising:
a display, a sensor, a sensor screen, or an optical surface;
an optical window attached to said electronic device for protecting said display, said sensor, said sensor screen, or said optical surface,
wherein said optical window is made using injection compression molding.

9. The electronic device of claim 8, wherein said electronic device is, a portable device, a wireless communication device, a mobile phone, a digital personal assistant or a camera.

10. The electronic device of claim 8, wherein said optical window has flat surfaces.

11. The electronic device of claim 8, wherein said optical window has at least one curved surface.

12. The electronic device of claim 8, wherein a quality of said optical window is determined by an optical birefringence, wherein said optical birefringence is defined by a difference in an index of refraction for two optical waves polarized in perpendicular directions and propagating through said optical window.

13. The electronic device of claim 8, wherein said optical window is made of polymethyl methacrylate (PMMA).

14. The electronic device of claim 8, wherein said making said optical window using injection compression molding, comprises:
expanding a volume of a cavity that its expanded thickness is larger than a desired thickness of said optical window by a predetermined value;
injecting a molten thermoplastic resin into said cavity through an injection cylinder;
compressing said cavity using moving at least one member of said cavity to a predetermined thickness which is within a prescribed tolerance of said desired thickness of said optical window, wherein said compressing is performed during or after said injecting and a speed, a moving distance and timing of said moving is pre-programmed by a system operator; and
taking out the obtained optical window from the cavity after the desired thickness of said optical window is formed.
